(19) United States
(12) Patent Application Publication
(10) Pub. No.: US 2026/0050753 A1
(43) Pub. Date: Feb. 19, 2026

(54) GUIDING LANGUAGE TRANSLATION WITH TRANSLATION DOCUMENTS USING MACHINE LEARNING

(71) Applicant: Adobe Inc., San Jose, CA (US)

(72) Inventors: Divyanshu Goyal, Sunnyvale, CA (US); Akhil Eppa, San Jose, CA (US); Mayank Anand, Fremont, CA (US)

(73) Assignee: Adobe Inc., San Jose, CA (US)

(21) Appl. No.: 18/808,820

(22) Filed: Aug. 19, 2024

(51) Int. Cl. G06F 40/58; G06F 40/51

(52) U.S. Cl. CPC G06F 40/58; G06F 40/51

(57) ABSTRACT

In accordance with the described techniques, a system receives a plurality of facets describing language-agnostic aspects of language translation, a translation document describing language-specific rules for translating from a source language to a target language, and a source text in the source language. Using one or more machine learning models, a plurality of guidelines are extracted from the translation document and assigned to respective facets of the plurality of facets. The system translates the source text to a translated text in the target language using one or more machine learning models conditioned on the plurality of guidelines assigned to the respective facets.

### BACKGROUND

Content culturalization in the context of language translation is the process of translating text written in a source language to a target language, while aligning with the cultural norms, values, and preferences of speakers of the target language. It involves modifying various elements of the text written in the source language such as imagery, humor, references, and formatting to ensure that translated text is culturally appropriate and resonates with regional audiences. Conventionally, content culturalization in the context of language translation is performed by skilled human translators through consultation of translation localization guides, which are documents outlining cultural, regional, and/or lingual nuances for translating from the source language to the target language. These translation localization guides are often produced by entities like brands or companies, and as such, the translation preferences contained therein are typically entity-specific for tailoring translated text to the entity's intended brand voice.

### SUMMARY

In accordance with the described techniques, a translation system receives a source text, a translation document, and a plurality of translation facets. The source text is a portion of text written in a source language that is requested to be translated to a target language. The translation document is a document produced by an entity that outlines entity-specific and language-specific rules and guidelines for translating from a source language to a target language. The translation facets are language-agnostic aspects, concepts, or considerations of language translation that are applicable to a plurality of languages. Conditioned on the translation document and the translation facets, a guideline extraction model extracts guidelines from the translation document, and assigns the extracted guidelines to respective translation facets. Conditioned on the source text and the extracted guidelines assigned to the respective translation facets, a translation model generates a translated text by translating the source text to the target language while adhering to the extracted guidelines. Conditioned on the translated text and the extracted guidelines assigned to the respective translation facets, a validation model generates a translation score for each translation facet capturing a degree to which the translated text adheres to one or more guidelines assigned to a respective translation facet. The translation system is configured to output (e.g., present in a user interface) the translated text, the translation facets, and the translation scores assigned to the translation facets.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ techniques described herein for guiding language translation with translation documents using machine learning.

FIG. 2 depicts a system in an example implementation showing operation of a translation system to translate a source text in a source language to a translated in a target language.

FIG. 3 depicts a system in an example implementation showing operation of a translation system to retrieve guidelines of translation associated with an entity and a translation direction from a pre-populated cache.

FIG. 4 depicts a system in an example implementation showing operation of a translation system to control output of translated text based on translation scores assigned to the translated text.

FIG. 5 depicts a system in an example implementation showing operation of a training module to train a translation model.

FIG. 6 depicts a system in an example implementation showing operation of a training module to train a validation model.

FIG. 7 depicts an example user interface for interacting with the translation system.

FIG. 8 is a flow diagram depicting a procedure in an example implementation for guiding language translation with translation documents using machine learning.

FIG. 9 is a flow diagram depicting a procedure in an example implementation for guiding language translation with translation documents using machine learning.

FIG. 10 illustrates an example system including various components of an example device that can be implemented as any type of computing device as described and/or utilized with reference to FIGS. 1-9 to implement embodiments of the techniques described herein.

### DETAILED DESCRIPTION

### Overview

In the context of language translation, content culturalization involves translating a text written in a source language to a target language, while modifying elements of the source material to align with cultural and lingual rules, norms, and values of the target language (and speakers thereof). This process is typically carried out by skilled human translators consulting translation documents (e.g., translation localization guides), which outline the cultural and lingual subtleties of translating from the source language to the target language. Translation documents are produced by entities, like brands, companies, or organizations, for the purpose of generating translated text that adheres to the entity's intended brand voice. As such, the translation preferences contained within these translation documents are entity-specific. Conventional automated language translation techniques fail to account for cultural and lingual nuances of language translation and entity-specific language translation preferences typically contained within translation documents. Rather, to account for this information, conventional techniques rely on manual human analysis of translation documents by skilled human translators, which is time-consuming and labor-intensive, results in inconsistent application of the guidelines contained within the translation documents, and limits scalability with respect to the size of the text being translated.

To overcome these limitations, techniques for guiding language translation with translation documents using machine learning are described herein, as implemented by a translation system. The translation system employs a guideline extraction model, a translation model, and a validation model (e.g., machine learning models or generative artificial intelligence (AI) models) for the task of content culturalization in the context of language translation. In the following discussion, the machine learning models are pre-trained large language models (LLMs) pre-trained to perform a variety of natural language processing (NLP) tasks, including language translation and question/prompt answering.

In accordance with the described techniques, the translation system receives a translation document and a plurality of translation facets. The translation document contains rules and guidelines of an entity for translating in accordance with a translation direction, e.g., from a particular source language to a particular target language. The rules and guidelines are specific to the entity, and specific to the direction of translation. The plurality of translation facets are language-agnostic aspects of language translation that are relevant across a plurality of languages. For purposes of clarity, the translation facets are language translation concepts or considerations that apply when translating in a plurality of translation directions, while the translation document contains language-specific rules that are categorizable within the translation facets. For example, the translation facet of “linguistic style” is a relevant consideration whether translating to German, French, or Japanese, though the particular guidelines that fit within the “linguistic style” translation facet vary across languages. In various implementations, each of the translation facets include a description, e.g., the translation facet of “linguistic style” includes a description of “adherence to stylistic choices that affect readability and engagement.”

Here, the guideline extraction model is configured to extract guidelines from the translation document that are categorizable within the translation facets, and assign the extracted guidelines to respective translation facets. As part of this, the guideline extraction model receives conditioning signals including the translation document, the translation facets (and the descriptions thereof), and a prompt instructing the guideline extraction model to extract the guidelines from the translation document and assign the extracted guidelines to the respective facets. In one or more implementations, the guideline extraction model is employed in an “off-the-shelf” manner, e.g., without any finetuning or refining being performed on the underlying LLM.

In one or more implementations, the translation system populates a cache with a cache entry that includes an indication of the particular entity associated with the translation document, an indication of the particular translation direction associated with the translation document, and the extracted guidelines assigned to the respective translation facets. The cache includes a plurality of cache entries, each of which includes a different set of guidelines assigned to the respective translation facets, as extracted from different translation documents associated with different entities and/or different translation directions. After having pre-populated the cache with the cache entry, the translation system receives a translation request that includes an indication of the particular entity submitting the translation request and an indication of the particular translation direction. In response, the translation system retrieves, from the cache, the set of guidelines grouped with the particular entity and the particular translation direction in the cache.

The received translation request additionally includes a source text composed in the source language that is requested to be translated to the target language by the translation system. Thus, after having retrieved the guidelines from the cache, a translation model is employed to generate translated text by translating the source text from the source language to the target language, while adhering to the retrieved guidelines. As part of this, the translation model receives conditioning signals including the source text, and the retrieved guidelines assigned to the respective translation facets. In one or more implementations, the translation model is employed in an “off-the-shelf” manner (e.g., without any finetuning or refining having been performed on the underlying LLM), and as such, the translation model additionally receives a prompt instructing the translation model to translate the source text to the target language in accordance with the extracted guidelines. In one or more alternative implementations, the translation model is a finetuned variant of the pre-trained LLM having been refined (e.g., using supervised learning) on a dataset of training samples each having a source text sample and a corresponding ground truth translated text sample having been translated in accordance with the guidelines.

The validation model is configured to generate, for each respective translation facet, a translation score capturing a degree to which the translated text adheres to the one or more guidelines assigned to the respective translation facet. As part of this, the validation model receives conditioning signals including the translated text and the retrieved guidelines assigned to the respective translation facets. In one or more implementations, the validation model is employed in an “off-the-shelf” manner (e.g., without any finetuning or refining having been performed on the underlying LLM), and as such, the validation model additionally receives one or more prompts instructing the validation model to generate translation scores for respective translation scores with respect to the guidelines assigned thereto. In one or more alternative implementations, the validation model is a finetuned variant of the pre-trained LLM having been refined (e.g., using supervised learning) on a dataset of training samples each having a text sample in the target language, and a translation score for a respective translation facet having been scored in accordance with the one or more guidelines assigned thereto.

In one or more implementations, the translation system controls output of the translated text based on the translation scores. For example, the translation system is configured to determine whether the translation scores meet a translation quality threshold. If one or more translation scores fall below the translation quality threshold, the translation system employs a pre-trained LLM to generate instructions for correcting the translated text with respect to the one or more translation facets that failed to meet the translation quality threshold. Next, the translation system employs the translation model to generate an updated translated text based on the generated instructions, e.g., by conditioning the translation model on a prompt that includes the generated instructions, the source text, the guidelines assigned to the respective translation facets, and/or the original translated text. This process is repeated until a translated text is generated having translation scores that satisfy the translation quality threshold. After this, the translation system presents the translated text that satisfies the translation quality threshold in a user interface along with the translation facets and associated translation scores.

Accordingly, the described techniques automatically (without human intervention apart from providing the translation request) translate the source text to the translated text in the target language while considering the entity-specific and language-specific translation preferences contained within the translation document. In other words, the described techniques automate the time consuming and tedious task of manually analyzing translation documents, which additionally improves translation consistency and translation quality in the translated text, e.g., by reducing the risk of the human-prone errors of inconsistent applying the guidelines in the translation document and incorrectly translating the source text.

By categorizing the extracted guidelines within a standardized list of translation facets, the described techniques further promote consistency by ensuring that the translation consistently applies the translation concepts and/or considerations within the list of translation facets. The translation quality is further improved through controlling output of the translated text based on the translation scores, which ensures that translated text that is output for display adheres to the extracted guidelines in accordance with a quantifiable threshold.

Automating content culturalization in the context of language translation also significantly reduces the time it takes to translate source text, and the translation time is relatively constant regardless of the amount of text to translate. In other words, the described techniques significantly increase translation scalability. Furthermore, use of the cache reduces translation latency, e.g., the time it takes to translate the source text. Indeed, by pre-populating the cache with the extracted guidelines, the translation system performs the computational processes for extracting the guidelines before the translation request is received, e.g., off the critical path. As such, these computational processes are avoided when processing the translation request, thereby reducing the computational load associated with processing the translation request.

### Term Descriptions

As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, a machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

As used herein, the term “entity” refers to a person, a brand (e.g., a purveyor of goods or services, a social media brand, etc.), a company, a business, or an organization. In various scenarios, an entity makes content (e.g., digital content) available to the public, e.g., by publishing the digital content online. Content associated with the entity is generated with the purpose of maintaining a tone and/or brand voice of the entity (e.g., a certain look and feel of the content associated with the entity), such as whether the content is humorous or serious, complex or simple, formal or casual, and so on.

As used herein, the term “source language” is a language in which a source text is composed, and the term “target language” is a language in which the source text is to be translated to. In the context of a translation request to translate a source text from English to German, the source language is English and the target language is German.

As used herein, the term “translation direction” refers to the particular source language being translated and a particular target language being translated to. The translation direction includes the two languages involved in a translation, and a directionality of the translation. In the context of a translation request to translate a source text from English to German, the translation direction refers to translation being performed from English to German.

As used herein, the term “source text” refers to a portion of text written in the source language that is requested to be translated to a target language. In the context of a translation request to translate the phrase “Hello, I am pleased to meet you” from English to German, the source text is the phrase “Hello, I am pleased to meet you.”

As used herein, the term “translation document” refers to a document (e.g., a portable document format (PDF) document) produced by an entity that contains language-specific rules for translating from a particular source language to a particular target language. Translation documents are often referred to as localization guides, localization style guides, or translation localization guides. In various scenarios, a translation document specifies how features of a source text (e.g., humor, references, imagery, formatting, etc.) are to be modified to align with cultural and lingual norms of a target language and/or speakers thereof. Due to the differences in brand voice intended by different entities, the guidelines contained within the translation documents are entity-specific. That is, translation documents produced by different entities for a same translation direction have different language translation preferences. Moreover, a translation document is language-specific in the sense that the translation rules and guidelines contained within translation documents outlining different translation directions are different.

As used herein, the term “translation facet” refers to a language-agnostic aspect of translation that is consistently applicable across different languages. In other words, the translation facet is a concept of language translation that is to be considered to facilitate accurate and complete language translation regardless of the translation direction. By way of example, the translation facet of “tense appropriateness” is a relevant consideration whether translating to German, French, or Japanese, even though the guidelines falling under “tense appropriateness” vary across different translation directions.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

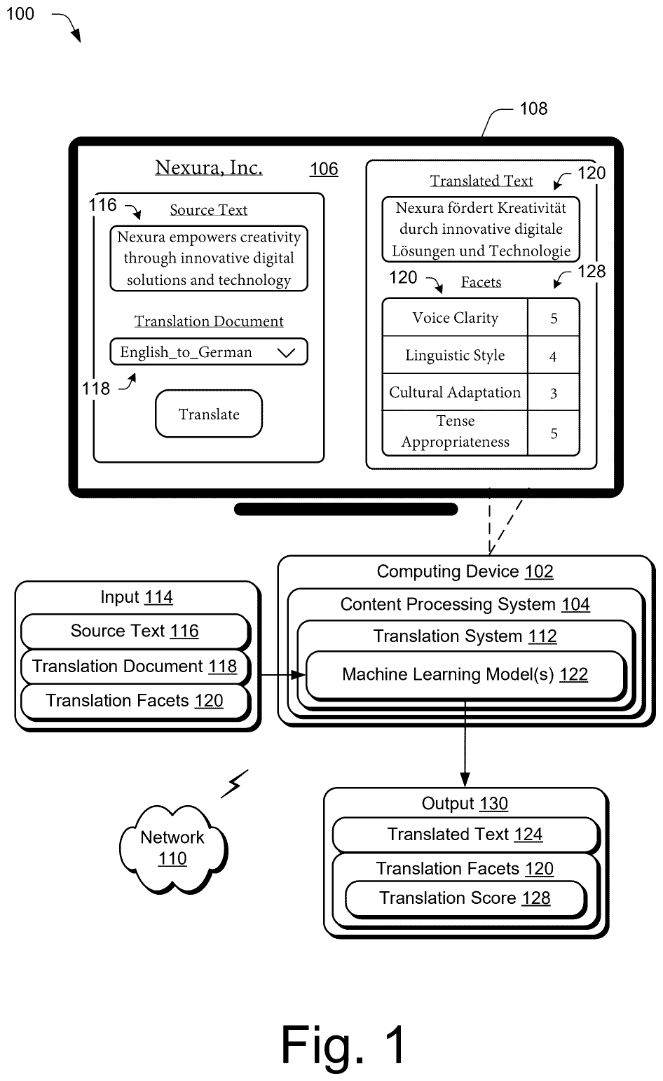

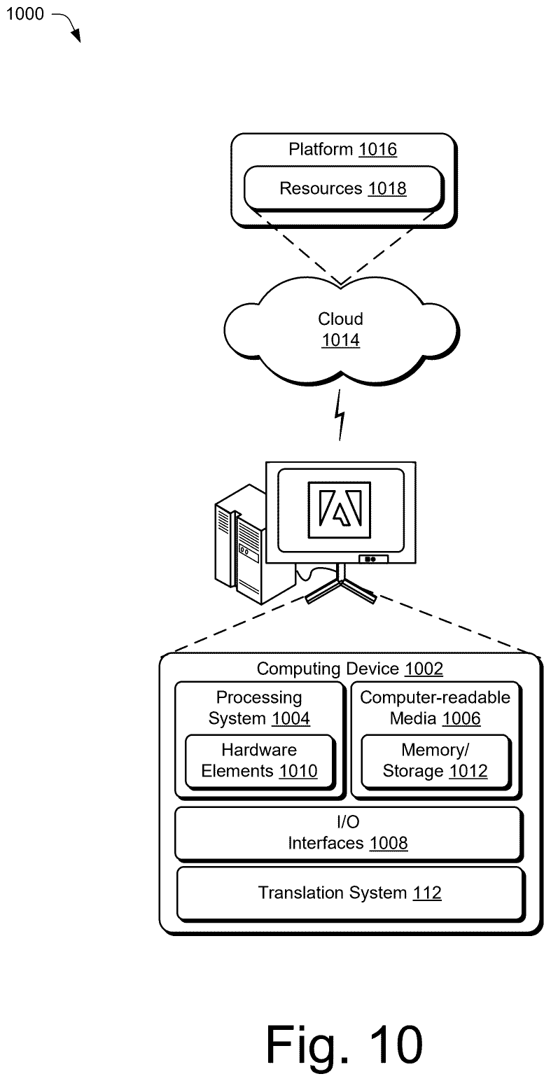

FIG. 1 is an illustration of an environment 100 in an example implementation that is operable to employ techniques described herein for guiding language translation with translation documents using machine learning. The illustrated environment 100 includes a computing device 102, which is configurable in a variety of ways. The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 10.

The computing device 102 is illustrated as including a content processing system 104. The content processing system 104 is implemented at least partially in hardware of the computing device 102 to process and transform digital content. Such processing includes creation of the digital content, modification of the digital content, and rendering of the digital content in a user interface 106 for output, e.g., by a display device 108. Although illustrated as implemented locally at the computing device 102, functionality of the content processing system 104 is also configurable as whole or part via functionality available via the network 110, such as part of a web service or “in the cloud.”

An example of functionality incorporated by the content processing system 104 to process the digital content is illustrated as a translation system 112. As shown, the translation system 112 receives, as input 114, a source text 116, a translation document 118, and a plurality of translation facets 120. In one or more implementations, the input 114 is received as a request to translate the source text 116 in a source language (e.g., English) to a target language, e.g., German. The translation document 118 is a document produced by an entity (e.g., a brand, a person, a company, an organization, and so on) that sets forth entity-specific rules for translating from the source language to the target language. Furthermore, the plurality of translation facets 120 represent language-agnostic aspects of language translation, e.g., concepts or considerations of language translation preferences that are relevant across a plurality of different languages. For instance, the translation facet 120 of “tense appropriateness” is the notion of choosing the correct tense to match the meaning of the source text, acknowledging that direct tense equivalents (e.g., future tense to future tense or past tense to past tense) may not always exist between languages.

As shown, the input 114 is provided to one or more machine learning models 122 of the translation system 112. In accordance with the described techniques, the one or more machine learning models 122 are configured to translate the source text 116 in the source language to translated text 124 in the target language. To do so, the one or more machine learning models 122 are employed to extract guidelines from the translation document 118, and assign the extracted guidelines to respective translation facets 120. In other words, the one or more machine learning models 122 take entity-specific and language-specific translation guidelines of the translation document 118, and categorize these guidelines within the language-agnostic translation facets 120. By way of example, the guidelines extracted for the translation facet 120 of “tense appropriateness” include “in general, translate English future tense to German present tense.” Conditioned on the extracted guidelines assigned to the respective translation facets 120, the one or more machine learning models 122 translate the source text 116 to the translated text 124.

Moreover, the one or more machine learning models 122 are configured to generate, for each of the translation facets 120, a translation score 128 capturing a degree to which the translated text 124 adheres to the guidelines extracted for a respective translation facet 120. Continuing with the previous example, a translation score 128 is assigned to the translation facet 120 of “tense appropriateness,” and the translation score 128 is based, at least in part, on how well future tense in the source text 116 (e.g., the English text) is converted to present tense in the translated text 124 (e.g., the German text). Accordingly, the one or more machine learning models 122 produce an output 130 that includes the translated text 124 and translation scores 128 assigned to each of the translation facets 120, e.g., the translation system 112 displays the translated text 124 and the translation scores 128 in the user interface 106, as shown.

Conventional automated language translation techniques fail to account for entity-specific and language-specific translation preferences. Instead, to account for this information, conventional techniques rely on human translators to consult translation documents. Manually analyzing translation documents is time-consuming and labor-intensive, results in inconsistent application of the guidelines embodied in the translation documents, and limits scalability with respect to the size of text being translated. In contrast, the described techniques provide a translation system 112 that automatically (e.g., without human intervention apart from providing the input 114) translates the source text 116 to the target language while considering the entity-specific and language-specific translation guidelines in the translation document 118. By doing so, the described techniques automate the time-consuming and labor-intensive task of manual translation document analysis, which enhances consistency in translated text, improves translation scalability, and improves translation quality by reducing the risk of human error. The translation scores 128 further promote translation quality by identifying particular translation facets 120 of the translated text 124 that can be updated to better align with the extracted guidelines.

### Document-Guided Translation Features

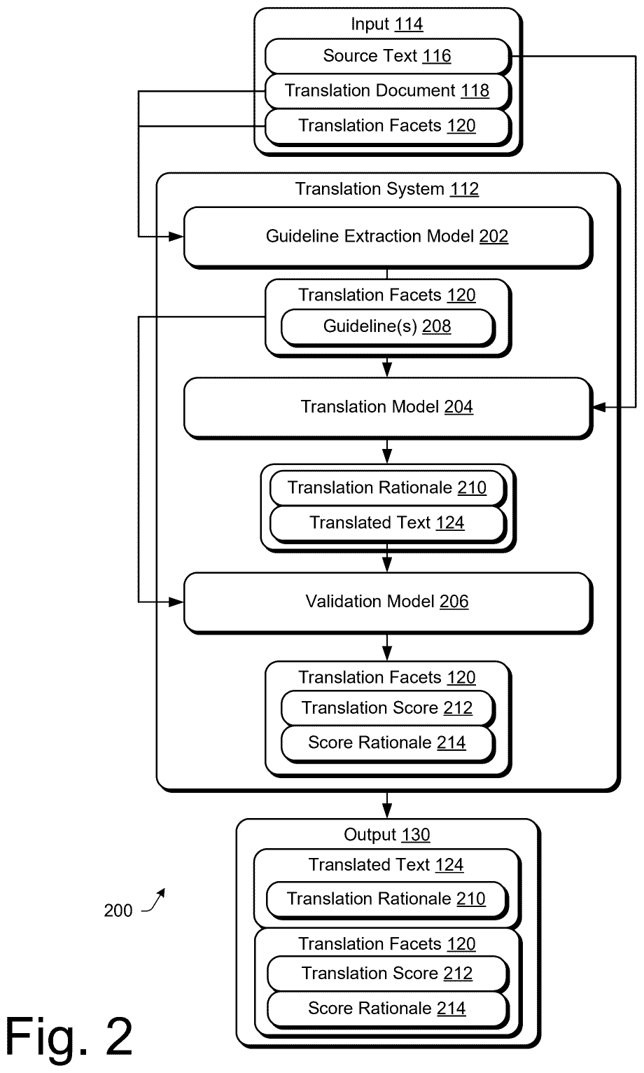

FIG. 2 depicts a system 200 in an example implementation showing operation of a translation system to translate a source text in a source language to a translated text in a target language. Here, the translation system 112 includes a guideline extraction model 202, a translation model 204, and a validation model 206, e.g., the one or more machine learning models 122 of FIG. 1. In various examples, one or more of the models 202, 204, 206 are large language models (LLMs) that have been pre-trained to perform a variety of natural language processing (NLP) tasks including language translation and prompt/question answering. Examples of such pre-trained LLMs include, but are not limited to including, a generative pre-trained transformer (GPT) model (e.g., GPT-2, GPT-3, or GPT-4), a Large Language Model Meta AI (LLaMA) model (e.g., LLaMA 1, LLaMA 2, or LLaMA 3), a Bidirectional Encoder Representations from Transformers (BERT) model, a Robustly Optimized BERT Approach (RoBERTa) model, and a Text-To-Text Transformer (T5) model.

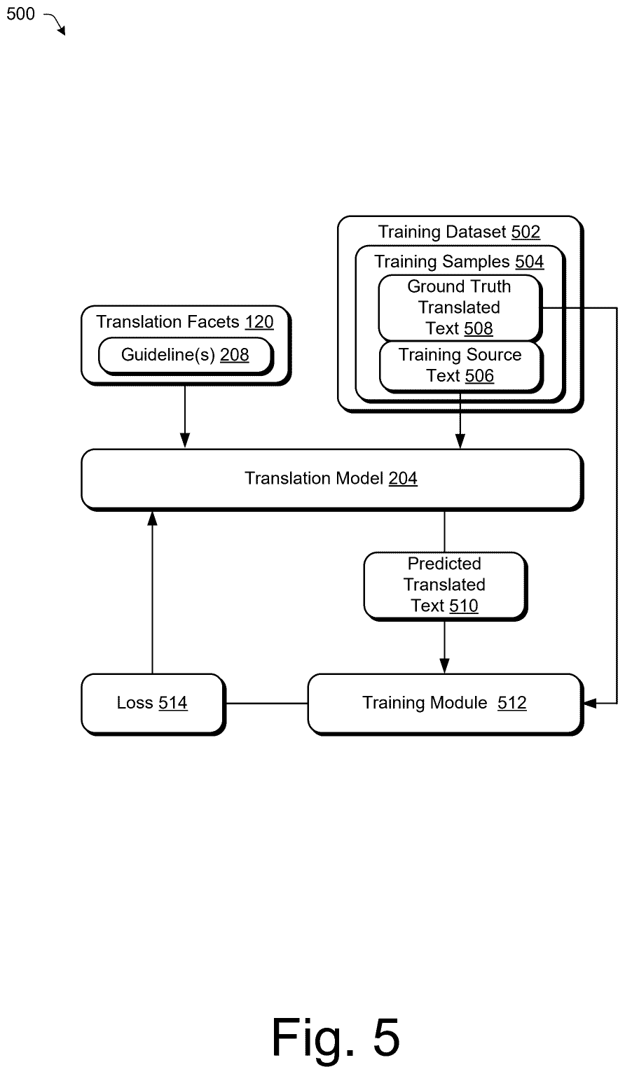

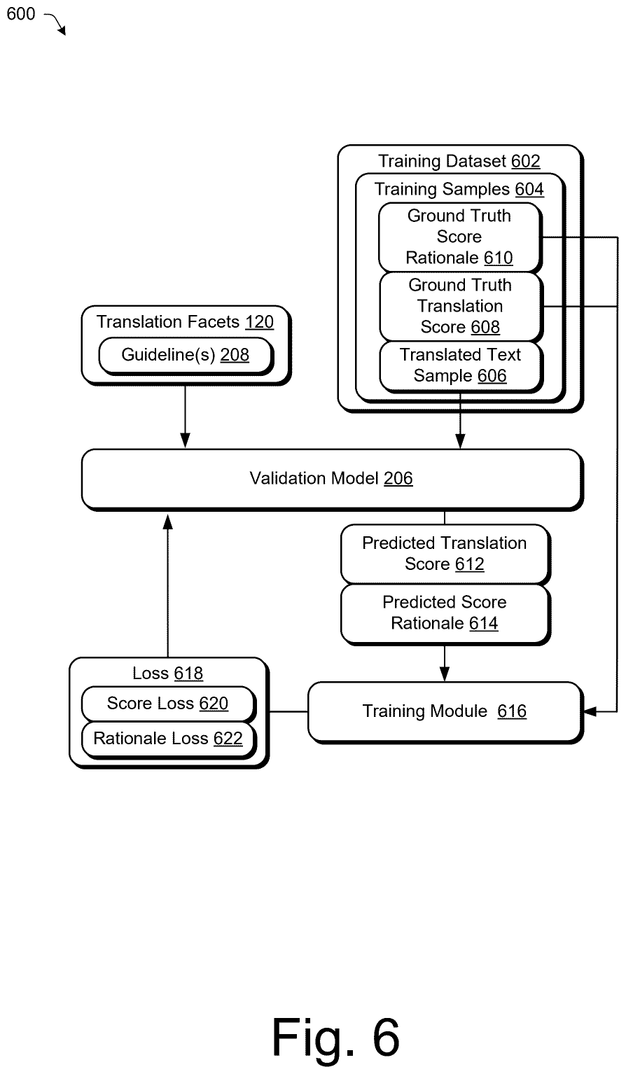

In various examples, one or more of the models 202, 204, 206 implemented as pre-trained LLMs are leveraged in an “off-the-shelf” manner. As part of this, an LLM is employed (e.g., via an application programming interface (API) call) without any additional refining or finetuning having been performed on the LLM. In such examples, prompts (e.g., textual prompts) describing tasks to be performed by the one or more models 202, 204, 206 are provided to the one or more models 202, 204, 206 to achieve the below-described model outputs. Additionally or alternatively, one or more of the models 202, 204, 206 implemented as pre-trained LLMs are refined and/or finetuned on different datasets to achieve the below-described model outputs. Additionally or alternatively, one or more of the models 202, 204, 206 are domain-specific models that are trained from scratch (e.g., starting from uninitialized or randomly initialized parameters) to achieve the below-described model outputs. Examples of training and/or finetuning the translation model 204 and the validation model 206 are described below with respect to FIGS. 5 and 6.

As shown, the translation system 112 receives, as input 114, a source text 116, a translation document 118, and the translation facets 120. The source text 116, for instance, is a portion of text written or composed in a source language that is requested to be translated to a target language by the translation system 112. In one or more examples, the translation document 118 is a portable document format (PDF) document that contains rules or guidelines of an entity for translating from a source language to a target language. Due to differences in tone and brand voice conveyed by different entities, the guidelines contained within the translation documents 118 is entity-specific. For example, translation documents 118 associated with a same translation direction but different entities contain different rules or guidelines for a particular translation facet 120. Furthermore, due to the differences in language and culture across languages, translation documents 118 outlining different translation directions also contain different rules or guidelines for a particular translation facet 120.

Moreover, the translation facets 120 are language-agnostic aspects of language translation that are relevant across many languages. In one or more examples, the translation facets 120 are received together with a plurality of translation dimensions, and the translation facets 120 are categorized within the translation dimensions. The translation dimensions are conceptualizable as language-agnostic categories of language translation, the translation facets 120 are conceptualizable as language-agnostic subcategories of language translation that fall under the translation dimensions, and the guidelines contained within the translation document 118 are conceptualizable as language-specific translation rules that fall under the translation dimensions and/or the translation facets 120. In one or more implementations, the list of translation dimensions and translation facets 120 are compiled as categories and subcategories of language translation concepts that consistently appear in translation documents 118 across different languages. In one or more examples, the translation dimensions and the translation facets 120 are received within a PDF document, and the PDF document additionally includes a natural language text description of each translation facet 120. Table 1 shows a non-limiting example of the translation dimensions, translation facets 120, and descriptions thereof received as part of the input 114.

TABLE 1
Translation Dimensions, Translation Facets, and Descriptions

| Translation | Translation | Facet |
|---|---|---|
| Dimensions | Facets | Descriptions |
| Voice and Tone | Voice Clarity | Maintaining clarity and consistency of the original voice |
| | | through linguistic and cultural adaptation. |
| | Tone Adaptation | Adjusting the emotional and formal undertones to match the |
| | | target audience's expectations. |
| | User Addressing | The way users are addressed in the content should be |
| | | appropriate for the target language and culture. |
| Style and Grammar | Linguistic Style | Adherence to stylistic choices that affect readability and |
| | | engagement. |
| | Grammatical | Correct grammar, syntax, and usage tailored to the target |
| | Accuracy | language. |
| | Inclusive and Bias- | Ensuring language use supports diversity and avoids |
| | Free Language | stereotypes. |
| | Word Order | Adjusting the sentence structure to match the grammatical |
| | | rules of the target language. |
| | Neutral Pronouns | Using gender-neutral pronouns or rephrasing sentences to |
| | | avoid gendered pronouns when the gender is unknown or |
| | | irrelevant. |
| | Tense | Choosing the correct tense to match the meaning of the |
| | Appropriateness | original, acknowledging that direct tense equivalents may not |
| | | always exist between languages. |
| Localization | Cultural and | Adjusting content to reflect local cultures, values, and |
| Considerations | Contextual | references. |
| | Adaptation | |
| | Political Neutrality | Ensuring content does not favor or disfavor political entities |
| | | or ideas unnecessarily. |
| | UI Element | Accurate translation and localization of user interface |
| | Translation | elements to ensure usability. |
| | Keyboard Layouts | Adapting keyboard input methods and shortcuts to match |
| | | local conventions. |
| Formatting Rules | Punctuation and | Adhering to language-specific punctuation, typography, and |
| | Typography | formatting rules. |
| | Abbreviations and | Use and translation of abbreviations and acronyms according |
| | Acronyms | to local standards. |
| | Country Standards | Following country-specific standards for dates, currency, |
| | | addresses, and other localized formats. |

As shown in FIG. 2, the guideline extraction model 202 receives conditioning signals including the translation document 118 and the translation facets 120, e.g., the PDF document containing the translation dimensions, the translation facets 120, and the descriptions of the translation facets 120. In one or more implementations, the guideline extraction model 202 is a pre-trained LLM that is leveraged in an “off-the-shelf” manner. Thus, although not shown, the translation system 112 additionally provides a prompt (e.g., a textual prompt) as an additional conditioning signal to the guideline extraction model 202 in various implementations. Generally, the prompt instructs the guideline extraction model 202 to extract guidelines 208 from the translation document 118 that fit within the provided translation facets 120, and assign the extracted guidelines 208 to respective translation facets 120. Thus, based on the prompt, the translation document 118, the translation dimensions, the translation facets 120, and the descriptions thereof, the guideline extraction model 202 outputs guidelines 208 extracted from the translation document 118 and assigned to respective translation facets 120. Table 2 shows a non-limiting example of guidelines 208 for translating from English to German, as extracted and assigned to respective translation facets 120 and translation dimensions by the guideline extraction model 202.

TABLE 2
Guidelines Extracted by the Guideline Extraction Model

| Translation | Translation | | Extracted |
|---|---|---|---|
| Dimensions | Facets | | Guidelines |
| Voice and Tone | Voice Clarity | 1. | “Maintain Entity's voice as simple, forward-thinking, |
| | | | and inspiring to foster an emotional connection with the |
| | | | community.” |
| | | 2. | “Ensure voice clarity by avoiding jargon and resonating |
| | | | with personality, making the content compelling and |
| | | | relatable.” |
| | | 3. | “Adapt the tone according to the audience, maintaining |
| | | | professionalism while varying the tone to sound more |
| | | | human and engaging.” |
| | Tone Adaptation | 1. | “Be direct, informative, clear, and concise.” |
| | | 2. | “Use the personal, active voice.” |
| | | 3. | “Maintain a friendly, yet professional tone.” |
| | | 4. | “Vary the tone according to the audience.” |
| | User Addressing | 1. | “Depending on the project, either the formal form of |
| | | | address (‘Sie’) or the informal form (‘du’) is to be used.” |
| | | 2. | “Directly address customers whenever the English |
| | | | original does, especially when a statement serves the |
| | | | purpose of showing customers what they can do with a |
| | | | product or feature.” |
| | | 3. | “For verbs in the imperative, follow the English pattern |
| | | | (translate as imperative).” |
| Style and | Linguistic Style | 1. | “Use a clear, succinct, logical, and accurate style to |
| Grammar | | | ensure the reader is unaware the text is a translation.” |
| | | 2. | “Adapt the translation tone and register to the specific |
| | | | audience of each document type.” |
| | | 3. | “Avoid ambiguous expressions and long, complicated |
| | | | sentences to enhance readability.” |
| | | 4. | “Maintain consistency in terminology and writing style |
| | | | across documents.” |
| | Grammatical | 1. | “Use the comma as the decimal separator and the period |
| | Accuracy | | for thousand separators.” |
| | | 2. | “Adopt a neutral tone and avoid using the second |
| | | | person pronoun as often as it is used in English.” |
| | | 3. | “Ensure grammatical accuracy by maintaining the |
| | | | correct word order in German, which may differ from |
| | | | English.” |
| | | 4. | “Use the formal ‘Sie’ for general translations unless |
| | | | instructed otherwise for specific audience types.” |
| | Inclusive and Bias- | 1. | “Use gender-neutral language to ensure inclusivity and |
| | Free Language | | avoid bias.” |
| | | 2. | “Adopt neutralization techniques for gender-neutral |
| | | | wording, such as using gender-neutral nouns or |
| | | | restructuring sentences.” |
| | | 3. | “For terms with more than one gender in German, refer |
| | | | to the specified gender in the gender list to ensure |
| | | | consistency in Entity's content.” |
| | | 4. | “Avoid using the generic masculine form in |
| | | | communication to prevent gender bias.” |
| | Word Order | 1. | “Always choose a word order that doesn't leave |
| | | | individual words isolated behind dependent clauses or |
| | | | interrupting phrases, especially in long and complex |
| | | | sentences.” |
| | | 2. | “In German, it is considered more reader-friendly to use |
| | | | the active voice. Please use active voice whenever |
| | | | appropriate.” |
| | | 3. | “Even if the English uses negatives, try to rephrase |
| | | | them. In German it is considered better style (and more |
| | | | user-friendly) to build positive sentences.” |
| | | 4. | “When translating procedures or steps to perform a |
| | | | particular action, list general information first and then |
| | | | give details. List UI elements in the order in which they |
| | | | appear in the interface.” |
| | Neutral Pronouns | 1. | “Avoid using gender-specific pronouns such as |
| | | | ‘er/ihn/sein’ or ‘sie/ihr/ihre’ for generic references where |
| | | | the gender is unknown or irrelevant.” |
| | | 2. | “Utilize gender-neutral language techniques such as |
| | | | neutralization, functional terms, and collective nouns to |
| | | | ensure inclusivity in translations.” |
| | | 3. | “When translating English content that uses gender- |
| | | | neutral pronouns like ‘they/them/theirs,’ adapt the |
| | | | translation to maintain gender neutrality in German.” |
| | | 4. | “Rephrase sentences if necessary to avoid gendered |
| | | | pronouns and ensure the translated content aligns with |
| | | | the inclusive language guidelines provided.” |
| | Tense | 1. | “In general, translate English future tense to German |
| | Appropriateness | | present tense.” |
| | | 2. | “Present tense is the preferred tense for both English |
| | | | and German documentation.” |
| | | 3. | “Do not use the second person pronoun and its forms |
| | | | (‘you,’ ‘your,’ etc.) as often as it is used in English. |
| | | | Adopt a neutral tone.” |
| Localization | Cultural and | 1. | “Use the formal form of address in documents that were |
| Considerations | Contextual | | authored by third parties, e.g. Forrester and Gartner.” |
| | | 2. | “For marketing content, use full sentences whenever |
| | | | possible. Descriptive paragraphs should not look like |
| | | | lists of items unless the formatting actually suggests a |
| | | | list.” |
| | Adaptation | 3. | “In German, there is a space between numbers and units |
| | Political Neutrality | | of measure (use a non-breaking space if a line-wrap |
| | | | might occur-this is not the case in tables).” |
| | | 1. | “Avoid using terms that may be considered politically |
| | | | charged or biased, such as ‘master/slave’ or |
| | | | ‘whitelist/blacklist,’ and instead opt for neutral |
| | | | language like ‘primary/replica’ or ‘allowlist/denylist.’” |
| | | 2. | “When translating geopolitical content, be sensitive to |
| | | | local perceptions and avoid references that may cause |
| | | | controversy, such as certain maps, flags, or historical |
| | | | events.” |
| | | 3. | “Ensure that the translation of enterprise content |
| | | | maintains political neutrality by not favoring or |
| | | | disfavoring any political entities or ideas.” |
| | UI Element | 1. | “Translate UI elements such as menus, buttons, |
| | Translation | | commands etc. in either infinitive or noun form.” |
| | | 2. | “Translate actions in verb form and other menu items |
| | | | that are nouns in English to nouns in German as well.” |
| | | 3. | “Ensure UI items are always translated consistently |
| | | | across the application.” |
| | | 4. | “Directly address the user in confirmation messages |
| | | | using the standard form of address required for the |
| | | | project.” |
| | Keyboard Layouts | 1. | “Ensure keyboard shortcuts are adapted to German |
| | | | standards, avoiding the use of accented or special |
| | | | characters.” |
| | | 2. | “Use the plus sign to indicate key combinations without |
| | | | spaces before or after the plus sign for German |
| | | | keyboard layouts.” |
| | | 3. | “Maintain consistency in translating UI elements related |
| | | | to keyboard layouts, ensuring that key names are not |
| | | | translated using all caps or boldface.” |
| Formatting Rules | Punctuation and | 1. | “Adhere to language-specific punctuation and |
| | Typography | | typography rules, such as using the correct quotation |
| | | | marks (“ ”) and the appropriate use of hyphens and |
| | | | dashes.” |
| | | 2. | “Ensure consistency in the use of punctuation within |
| | | | lists, headings, and tables, following German |
| | | | grammatical structures and capitalization rules.” |
| | | 3. | “Apply the correct formatting for numbers, dates, and |
| | | | times, utilizing the German standards such as commas |
| | | | for decimal separators and periods for thousand |
| | | | separators.” |
| | | 4. | “Maintain the integrity of product names, trademarks, |
| | | | and other non-translatable items, ensuring they remain |
| | | | in English as per Entity's guidelines.” |
| | Abbreviations and | 1. | “Provide a translation in parentheses of abbreviations |
| | Acronyms | | and acronyms the first time they occur in the text.” |
| | | 2. | “Do not use abbreviations unless this is strictly |
| | | | necessary.” |
| | Country Standards | 1. | “Translators are expected to follow all applicable |
| | | | country standards regarding units, numbers, time etc.” |
| | | 2. | “Use metric units only, and convert English non-metric |
| | | | units (inches, feet, degrees Fahrenheit, etc.), if |
| | | | necessary.” |
| | | 3. | “The correct order of fields in a German address is: |
| | | | Form of Address, Name, Company, Street Number, Zip |
| | | | Code + City Name, Country.” |
| | | 4. | “Use the common German linguistic rules for date and |
| | | | time handling. The order is always: day, month, year.” |

Thus, the described techniques categorize extracted guidelines 208 within a standardized list of translation dimensions and translation facets 120 regardless of a translation direction and an entity for which the translation is to be carried out. By doing so, the described techniques apply a consistent framework for language translation, ensuring that cultural and language-specific nuances of language translation are captured. This enables the translation model 204 to consistently generate translations that consider each of the translation dimensions and translation facets 120, ensuring consistent and complete language translation across different languages and different entity-specific language translation preferences.

As shown in FIG. 2, the translation model receives conditioning signals including the source text 116 and the guidelines 208 assigned to the respective translation facets 120. As output, the translation model 204 translates the source text 116 to a translated text 124 in the target language while adhering to the guidelines 208. In other words, the translation model 204 generates the translated text 124 while considering the source text 116, the extracted guidelines 208, and the translation dimensions and translation facets 120 that the extracted guidelines fall under. In various examples, translating the source text 116 includes modifying terms or phrases in the source text 116 to accord with the extracted guidelines 208, e.g., identifying and replacing humor that does not translate well to the target culture, adapting references or metaphors to be culturally relevant for speakers of the target language, and adjusting formatting elements like dates, times, or measurements to adhere to the target language. In addition, the translation model 204 generates a translation rationale 210 including natural language text explaining how the translated text 124 adheres to the extracted guidelines 208.

In one or more implementations, the translation model 204 is trained or finetuned specifically for the task of translating from the source language to the target language while adhering to the extracted guidelines 208, as further discussed below with reference to FIG. 5. Additionally or alternatively, the translation model 204 is a pre-trained LLM leveraged in an “off-the-shelf” manner. Thus, although not shown, the translation system 112 additionally provides a prompt (e.g., a textual prompt) as an additional conditioning signal to the translation model 204 in various implementations.

In such scenarios, the prompt instructs the translation model 204 to (1) translate the source text 116 from the source language to the target language while adhering to the extracted guidelines 208, and (2) generate a natural language explanation of how the translated text 124 adheres to the extracted guidelines. In at least one example scenario, the translation model 204 is called just once using a single prompt that encapsulates each of the translation facets 120. In at least one additional example, the translation model 204 is called multiple times (e.g., once for each translation dimension or once for each translation facet 120) using different, curated prompts concentrating on different translation dimensions or different translation facets 120. In this example, each LLM call progressively refines the translated text 124.

As shown, the validation model 206 receives conditioning signals including the translated text 124, and the extracted guidelines 208 assigned to the respective translation facets 120. As output, the validation model 206 generates, for each respective translation facet 120, a translation score 212 and a score rationale 214. A translation score 212 for a respective translation facet 120 represents a degree to which the translated text 124 corresponds with the one or more guidelines 208 assigned to the respective facet 120. In one or more examples, the translation scores 212 are provided on a Likert scale from zero to five. Here, a score of zero indicates that the respective translation facet 120 is not applicable to the source text 116, e.g., the source text 116 is lacking the type of content that is controlled by the translation facet 120. Further, a score within the range of one to five represents a degree to which the translated text 124 accords with the one or more guidelines 208 assigned to a respective facet 120, with one representing a complete lack of adherence to the one or more guidelines 208 and five representing that the translated text 124 fully and completely adheres to the one or more guidelines 208.

Moreover, a score rationale 214 for a respective translation facet 120 includes natural language text explaining how the translated text 124 adheres to the one or more guidelines 208 assigned to the respective translation facet 120, i.e., an explanation for the translation score 212. In implementations in which the translation score 212 is non-zero (e.g., the respective translation facet 120 is applicable) but less than a threshold score (e.g., less than five on the aforementioned Likert scale), the score rationale 214 includes an indication (e.g., a quotation) of the offending language in the translated text 124 that causes the translation score 212 to fall below the threshold score.

In one or more implementations, the validation model 206 is trained or finetuned specifically for the task of (1) generating the translation scores 212, and (2) generating score rationales 214, as further discussed below with reference to FIG. 6. Additionally or alternatively, the validation model 206 is a pre-trained LLM leveraged in an “off-the-shelf” manner. Thus, although not shown, the translation system 112 provides a prompt (e.g., a textual prompt) as an additional conditioning signal to the validation model 206 in various implementations. Generally, the prompt instructs the validation model 206 to (1) generate, for each respective translation facet 120, a translation score 212 indicating a degree to which the translated text 124 adheres to the guidelines 208 of the respective translation facet 120, and (2) generate, for each respective translation score 212, a score rationale 214 explaining how the one or more guidelines 208 accord with the respective translation facet 120.

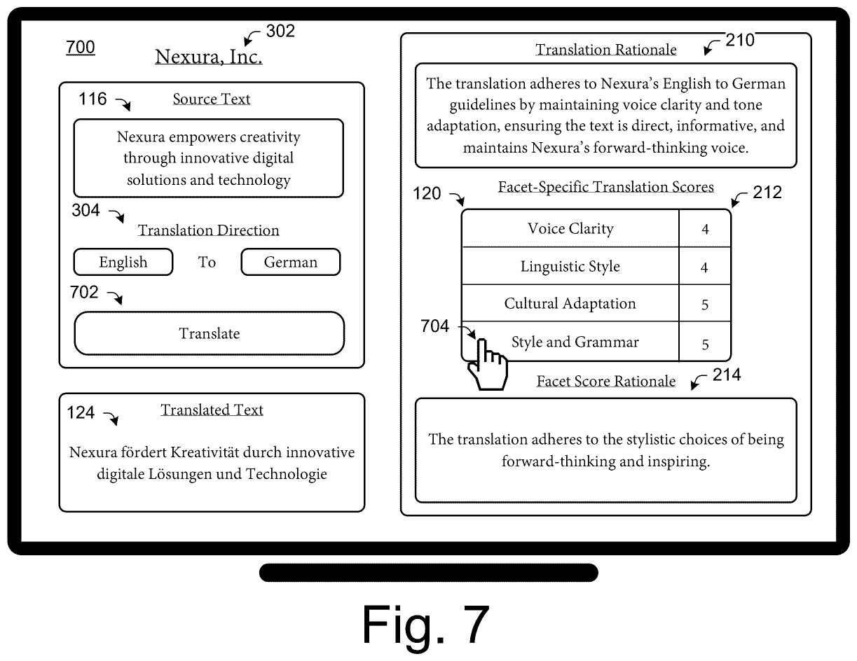

As illustrated, the translation system 112 produces an output 130 that includes the translated text 124 and the translation rationale 210 for the translated text 124, as well as the translation scores 212 and score rationales 214 associated with respective translation facets 120. For example, the translation system 112 presents the translated text 124, the translation rationale 210, the translation facets 120, the translation scores 212, and the score rationales 214 in a user interface 106 of a display device 108, as further discussed below with reference to FIG. 7.

Although examples are described herein in which the translation system 112 translates the source text 116 to the target language, it is to be appreciated that the source text 116 is contained within different content modalities, e.g., image or video content. By way of example, the translation system 112 receives an image or a video that includes text. Further, the translation system 112 generates an updated image or an updated video by translating the text within the image or the video in accordance with the described techniques, and replacing the original text with the translated text 124.

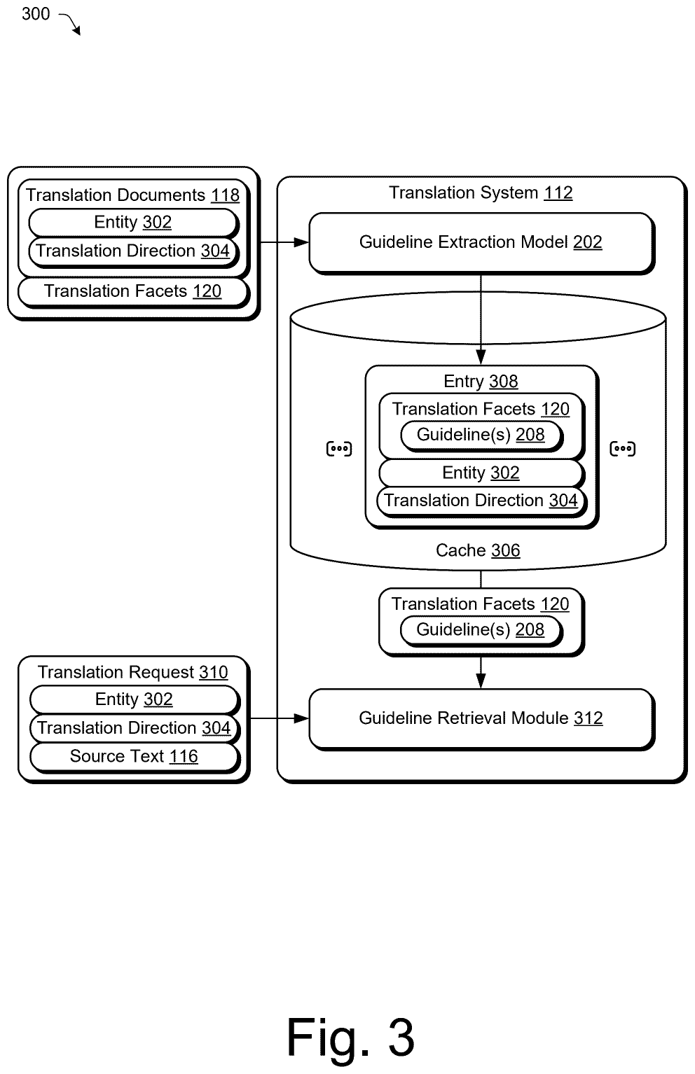

FIG. 3 depicts a system 300 in an example implementation showing operation of a translation system to retrieve guidelines of translation associated with an entity and a translation direction from a pre-populated cache. As shown, the guideline extraction model 202 receives a plurality of translation documents 118 and the plurality of translation facets 120, e.g., the PDF document containing the translation dimensions, the translation facets 120, and the descriptions of the translation facets 120. Furthermore, each translation document 118 includes an indication of an entity 302 and an indication of a translation direction 304. The entity 302 is the brand, person, company, or organization that produced the translation document 118, and the translation document 118 includes language translation preferences specific to the entity 302. Moreover, the translation direction 304 specifies the source language and the target language of the translation document 118, e.g., the translation document 118 includes language-specific rules for translating from a particular source language to a particular target language. Different translation documents 118 are associated with different entities 302 and/or different translation directions 304.

Given a respective translation document 118, the guideline extraction model 202 extracts the guidelines 208 from the respective translation document 118, and assigns the extracted guidelines 208 to respective translation facets 120 in accordance with the techniques described herein. Furthermore, the translation system 112 populates a cache 306 with an entry 308 for the respective translation document 118. As shown, the entry 308 includes the guidelines 208 extracted from the respective translation document 118 and assigned to the respective translation facets 120, as well as indications of the entity 302 and the translation direction 304 associated with the respective translation document 118. In one or more implementations, the cache 306 includes the entity 302 and the translation direction 304 as a key of a key-value pair, and the cache 306 includes the set of guidelines 208 as a value of the key-value pair. This process is repeated for each of the translation documents 118, resulting in a plurality of entries 308 each having different sets of guidelines 208 that are cached with different entity 302 indications and/or different translation direction 304 indications.

After the entries 308 associated with each of the translation documents 118 are cached, the translation system 112 receives a translation request 310. As shown, the translation request 310 includes the source text 116, an indication of the entity 302 submitting the translation request 310, and an indication of the translation direction 304. By way of example, a user provides user input (e.g., to the user interface 106 of the translation system 112) providing authentication credentials (e.g., a password, PIN, or biometric authentication data) to login to a trusted user account associated with the entity 302. Given this, the translation system 112 determines the entity 302 associated with the translation request 310 based on the translation request 310 being received from the trusted user account. Furthermore, a user provides user input (e.g., to the user interface 106 of the translation system 112) specifying the translation direction 304.

In one or more implementations, a guideline retrieval module 312 is employed to retrieve from the cache 306, the set of guidelines 208 associated with the entity 302 and the translation direction 304 of the translation request 310. To do so, the guideline retrieval module 312 submits a query to the cache 306 that includes the entity 302 and the translation direction 304, e.g., the key of the key-value pair. In response, the cache 306 returns a response that includes a set of guidelines 208 assigned to the respective facets 120 that are grouped with the entity 302 and the translation direction 304 in the cache 306, e.g., the value of the key-value pair. Once retrieved, the set of guidelines 208 are provided to the translation model 204 along with the source text 116, and the translation model 204 translates the source text to the target language based on the retrieved guidelines 208, in accordance with the techniques discussed herein.

Pre-populating the cache 306 with the entries 308 in the manner described reduces translation latency, e.g., the time it takes to output the translated text 124. This is because the computational processes to extract the guidelines 208 from the translation document 118 and assign the guidelines 208 to the respective translation facets 120 occur off the critical translation path. In the system 300, for instance, the translation system 112 and/or the guideline extraction model 202 perform these computational processes before receiving the translation request 310, and as such, avoid these computational processes when processing the translation request. Accordingly, obtaining the guidelines 208 from the pre-populated cache 306 in the manner described is faster than extracting and assigning the guidelines 208 when the translation request 310 is received.

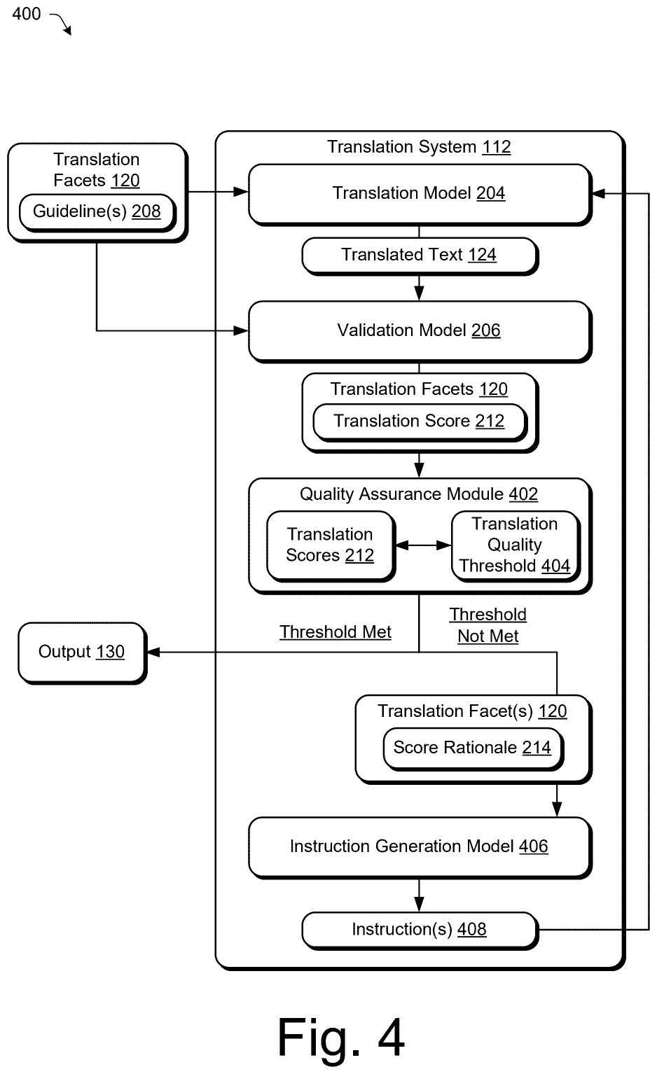

FIG. 4 depicts a system 400 in an example implementation showing operation of a translation system to control output of translated text based on translation scores assigned to the translated text. In the system 400, the translation model 204 translates the source text 116 in the source language to the translated text 124 in the target language, in accordance with the techniques discussed herein. Furthermore, the validation model 206 generates, for each respective translation facet 120, a translation score 212 representing a degree to which the translated text 124 adheres to the one or more guidelines 208 of the respective translation facet 120, in accordance with the techniques discussed herein.

As shown, the translation scores 212 are provided to a quality assurance module 402 which compares the translation scores 212 to a translation quality threshold 404. In one or more examples, the quality assurance module 402 computes an average of the translation scores 212, and determines whether the translation quality threshold 404 is met based on whether the average translation score exceeds the translation quality threshold 404. Additionally or alternatively, the quality assurance module 402 individually compares each of the translation scores 212 to the translation quality threshold 404. Here, the threshold is met if each individual translation score 212 is greater than or equal to the translation quality threshold 404, and the threshold is not met if at least one individual translation score 212 falls below the translation quality threshold 404. As previously mentioned, translation scores 212 of zero are indicative of translation facets 120 that are not applicable to the source text 116. Accordingly, translation scores 212 of zero are excluded from consideration by the quality assurance module 402 when determining whether the translation quality threshold 404 is met.

If the threshold is met, then the translation system 112 produces the output 130, e.g., the translation system presents the translated text 124 in the user interface 106. If the threshold is not met, an instruction generation model 406 is employed to generate one or more instructions 408 for correcting the translated text 124 with respect to one or more translation facets 120 having translation scores 212 that fall below the translation quality threshold 404.

By way of example, the instruction generation model 406 receives conditioning signals including one or more translation facets 120 having translation scores 212 that fall below the translation quality threshold 404 and score rationales 214 generated for the one or more translation facets 120. In one or more implementations, the instruction generation model 406 is a pre-trained LLM that is leveraged in an “off-the-shelf” manner. Thus, although not shown, the translation system 112 additionally provides a prompt (e.g., a textual prompt) as an additional conditioning signal to the instruction generation model 406 in various implementations. Generally, the prompt instructs the instruction generation model 406 to generate, for each translation facet 120 that does not meet the translation quality threshold 404, an instruction 408 that includes natural language text explaining how to correct the translated text 124 with respect to the translation facet 120. In various examples, the instruction generation model 406 extracts, from the score rationale 214, a word, phrase, or sentence that is identified in the score rationale 214 as the cause for the low translation score 212, and incorporates the word, phrase, or sentence into the instruction 408.

As shown, the one or more instructions 408 are used to re-prompt the translation model 204, and the translation model 204 is configured to generate an updated translated text based, in part, on the one or more instructions 408. For example, the translation system 112 generates an updated prompt by incorporating the instructions 408 into an existing prompt that was provided as a conditioning signal to the translation model 204 when the translated text 124 was initially generated. Alternatively, the translation system 112 generates a new prompt that includes the one or more instructions 408. In one or more implementations, the source text 116, the guidelines 208 assigned to the respective translation facets 120, and the original translated text 124 are additionally provided as conditioning signals to the translation model 204 in order to generate the updated translated text. This process repeated iteratively until a translated text is generated that satisfies the translation quality threshold 404. By doing so, the described techniques improve translation quality by outputting translated text 124 that adheres to the extracted guidelines 208 in accordance with a quantifiable threshold.

FIG. 5 depicts a system 500 in an example implementation showing operation of a training module to train a translation model. In particular, the described operations of the system 500 are operable to finetune the translation model 204 implemented as a pre-trained LLM, or train the translation model 204 from scratch, e.g., starting from uninitialized or randomly initialized parameters. During training, the translation model 204 receives the guidelines 208 assigned to the respective translation facets 120 as extracted from a translation document 118 associated with a particular entity 302 and a particular translation direction 304, e.g., specifying a particular source language and a particular target language.

The translation model 204 is trained on a training dataset 502 including a plurality of training samples 504. Each of the training samples 504 include a training source text 506 in the particular source language, and a ground truth translated text 508 in the particular target language. By way of example, skilled human translators translate the training source text 116 in the source language to the ground truth translated text 508 in the target language while consulting the translation document 118, e.g., the ground truth translated text 508 has been translated in accordance with the translation document 118.

As shown, the translation model 204 receives the training source text 506 of a training sample 504. In accordance with the described techniques, the translation model 204 outputs a predicted translated text 510 by translating the training source text 506 to the target language while adhering to the extracted guidelines 208. The predicted translated text 510 as well as the ground truth translated text 508 are provided to a training module 512, which computes a loss 514 (e.g., cross-entropy loss) between the predicted translated text 510 and the ground truth translated text 508. To enable such a loss comparison, the predicted translated text 510 and the ground truth translated text 508 are vectorized using one or more vectorization techniques that capture the semantic meaning of the underlying text being vectorized, e.g., a Word2Vec model, a Global Vectors for Word Representation (GloVE) model, or a sentence-BERT model. In other words, the predicted translated text 510 and the ground truth translated text 508 are converted to vectors of numbers representing the underlying text and capturing the semantic meaning of the underlying text. The loss 514 is computed by comparing the vector representations of the predicted translated text 510 and the ground truth translated text 508, and as such, the loss 514 captures semantic similarity between the predicted translated text 510 and the ground truth translated text 508.

After the loss 514 is computed, the training module 512 adjusts parameters (e.g., internal weights) of the translation model 204 to minimize the loss 514. The above-described process is repeated on different training samples 504 to iteratively adjust the parameters of the translation model 204 until the loss 514 converges to a minimum, a threshold number of iterations have completed, or a threshold number of epochs have been processed. As a result, the translation model 204 is trained to translate source text 116 in the particular source language to translated text 124 in the particular target language while adhering to the guidelines 208 extracted from a translation document 118 associated with a particular entity 302. In other words, the translation model 204 is trained in accordance with the guidelines 208 embodied in the particular translation document 118 associated with the particular entity 302 and the particular translation direction 304. However, it is to be appreciated that different instances of the translation model 204 are separately trainable and employable to translate text while adhering to the guidelines 208 embodied in different translation documents 118 associated with different entities 302 and/or different translation directions 304 using similar techniques.

FIG. 6 depicts a system 600 in an example implementation showing operation of a training module to train a validation model. In particular, the described operations of the system 600 are operable to finetune the validation model 206 implemented as a pre-trained LLM, or train the validation model 206 from scratch, e.g., starting from uninitialized or randomly initialized parameters. During training, the validation model 206 receives the guidelines 208 as extracted from a translation document 118 associated with a particular entity 302 and a particular translation direction 304, e.g., specifying a particular source language and a particular target language.

The validation model 206 is trained on a training dataset 602 including a plurality of training samples 604. Each of the training samples 604 includes a translated text sample 606 in the target language, a ground truth translation score 608 for the translated text sample 606 with respect to a respective translation facet 120, and a ground truth score rationale 610 for the ground truth translation score 608. The ground truth translation score 608 is generated by skilled human translators judging a degree to which the translated text sample 606 adheres to the one or more extracted guidelines 208 assigned to the respective translation facet 120. Further, the ground truth score rationale 610 is generated by skilled human translators providing an explanation of the ground truth translation score 608, e.g., explaining how the translated text sample 606 adheres to the one or more extracted guidelines 208 assigned to the respective translation facet 120. Notably, multiple training samples 604 containing a same translated text sample 606 exist in the training dataset 602, and the multiple training samples 604 contain different ground truth translation scores 608 and different ground truth score rationales 610 as analyzed with respect to different translation facets 120.

As shown, the validation model 206 receives the translated text sample 606. In accordance with the described techniques, the validation model 206 outputs a predicted translation score 612 capturing a degree to which the translated text sample 606 adheres to the one or more guidelines 208 assigned to the respective translation facet 120. In addition, the validation model 206 outputs a predicted score rationale 614 explaining how the translated text sample 606 adheres to the one or more guidelines 208 assigned to the respective translation facet 120. The predicted translation score 612, the predicted score rationale 614, the ground truth translation score 608, and the ground truth score rationale 610 are provided to a training module 616. Generally, the training module 616 is configured to compute a loss 618 that includes two loss terms—a score loss 620 and a rationale loss 622. To compute the score loss 620, the training module 616 computes a difference between the predicted translation score 612 and the ground truth translation score 608.

To compute the rationale loss 622, the predicted score rationale 614 and the ground truth score rationale 610 are vectorized using one or more vectorization techniques that capture the semantic meaning of the underlying text being vectorized, e.g., a Word2Vec model, a Global Vectors for Word Representation (GloVE) model, or a sentence-BERT model. In other words, the predicted score rationale 614 and the ground truth score rationale 610 are converted to vectors of numbers representing the underlying text and capturing the semantic meaning of the underlying text. The rationale loss 622 is computed by comparing the vector representations of the predicted score rationale 614 and the ground truth score rationale 610, and as such, the rationale loss 622 captures semantic similarity between the predicted score rationale 614 and the ground truth score rationale 610. The loss 618 is computed by combining the score loss 620 and the rationale loss 622, and optionally, weighting the score loss 620 and the rationale loss 622 differently.

After the loss 618 is computed, the training module 616 adjusts parameters (e.g., internal weights) of the validation model 206 to minimize the loss 618. The above-described process is repeated on different training samples 604 to iteratively adjust the parameters of the validation model 206 until the loss 618 converges to a minimum, a threshold number of iterations have completed, or a threshold number of epochs have been processed. As a result, the validation model 206 learns to generate translation scores 212 (and score rationales 214 thereof) for the translation facets 120 with respect to the guidelines 208 extracted from a translation document 118 associated with a particular entity 302 and a particular translation direction 304. However, it is to be appreciated that different instances of the validation model 206 are separately trainable and employable to generate translation scores 212 (and score rationales 214 thereof) for the translation facets 120 with respect to different guidelines 208 embodied in different translation documents 118 associated with different entities 302 and different translation directions 304.

FIG. 7 depicts an example user interface 700 for interacting with the translation system. As shown, the entity 302 “Nexura, Inc.” is requesting the translation system 112 to translate a source text 116 in accordance with a translation direction 304. By way of example, the user interface 700 is displayed responsive to user input providing authentication credentials to login to a trusted user account associated with the entity 302 “Nexura, Inc.” As shown, the user interface 700 includes a source text input region via which a user has input the source text 116 in the source language, e.g., English. Moreover, the user interface includes a translation direction input region via which a user has specified the translation direction 304 from the source language (e.g., English) to the target language, e.g., German. Furthermore, the user interface 700 includes a user interface element 702 that is selectable to submit the translation request 310, including an indication of the entity 302, an indication of the translation direction 304, and the source text 116.

In response to a selection of the user interface element 702, therefore, the translation system 112 receives the translation request 310, and produces the output 130 in accordance with the techniques described herein. For instance, the translation system 112 presents the translated text 124 and the translation rationale 210 in the user interface 700. In addition, the translation system 112 presents the translation facets 120, the translation scores 212 generated for the respective translation facets 120, and a score rationale 214 for one of the translation scores 212. In particular, the translation system 112 is configured to receive a user input selecting one of the translation facets 120, and in response, present the score rationale 214 for the translation score 212 assigned to the selected translation facet 120. In the illustrated example, for instance, the translation system 112 receives a user input selecting the translation facet 120 “style and grammar,” as shown at 704. In response, the translation system 112 presents the score rationale 214 generated for the translation facet 120 “style and grammar.”

### Example Procedures

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks.

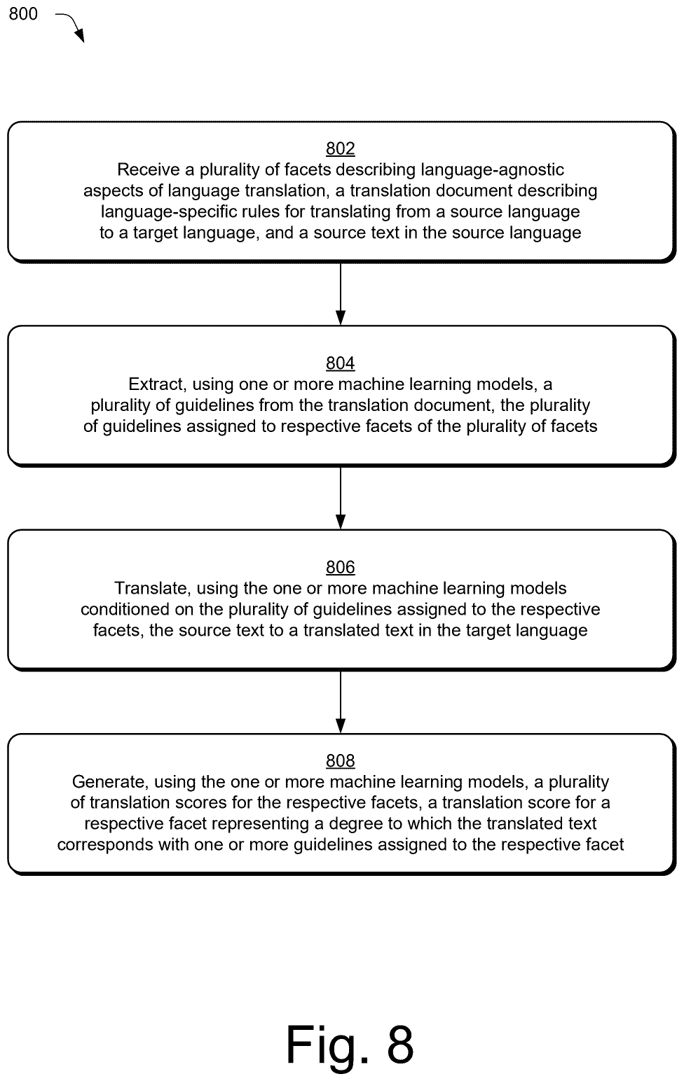

FIG. 8 is a flow diagram depicting a procedure 800 in an example implementation for guiding language translation with translation documents using machine learning. In the procedure 800, a plurality of facets describing language-agnostic aspects of language translation, a translation document describing language-specific rules for translating from a source language to a target language, and a source text in the source language are received (block 802). By way of example, the translation system 112 receives a translation document 118 associated with a particular entity 302 and a particular translation direction 304, e.g., specifying entity-specific guidelines for translating text from a source language to a target language. In addition, the translation system 112 receives the translation facets 120 describing the language-agnostic aspects of language translation that are consistently applicable across different translation directions 304.

A plurality of guidelines are extracted from the translation document using one or more machine learning models, and the plurality of guidelines are assigned to respective facets of the plurality of facets (block 804). For instance, the guideline extraction signal receives conditioning signals including the translation document 118 and the translation facets 120. Based on the conditioning signals, the guideline extraction model 202 extracts guidelines 208 that are categorizable within the translation facets 120, and assigns the extracted guidelines 208 to respective translation facets 120.

The source text is translated to a translated text in the target language using the one or more machine learning models conditioned on the plurality of guidelines assigned to the respective facets (block 806). For instance, the translation model 204 receives conditioning signals including the source text 116 and the extracted guidelines 208 assigned to the respective translation facets 120. Based on the conditioning signals, the translation model 204 translates the source text 116 to the translated text 124 in the target language while adhering to the extracted guidelines 208.

A plurality of translation scores are generated for the respective facets using the one or more machine learning models, and a translation score for a respective facet represents a degree to which the translated text corresponds with one or more guidelines assigned to the respective facet (block 808). For instance, the validation model 206 receives conditioning signals including the translated text 124 and the extracted guidelines 208 assigned to the respective translation facets 120. Based on the conditioning signals, the validation model 206 generates a translation score 212 for each respective translation facet 120 capturing a degree to which the translated text 124 corresponds with the one or more extracted guidelines 208 assigned to the respective translation facet 120. In one or more implementations, the translation system 112 controls output of the translated text 124 based on the translation scores 212, as further discussed above with reference to FIG. 4.

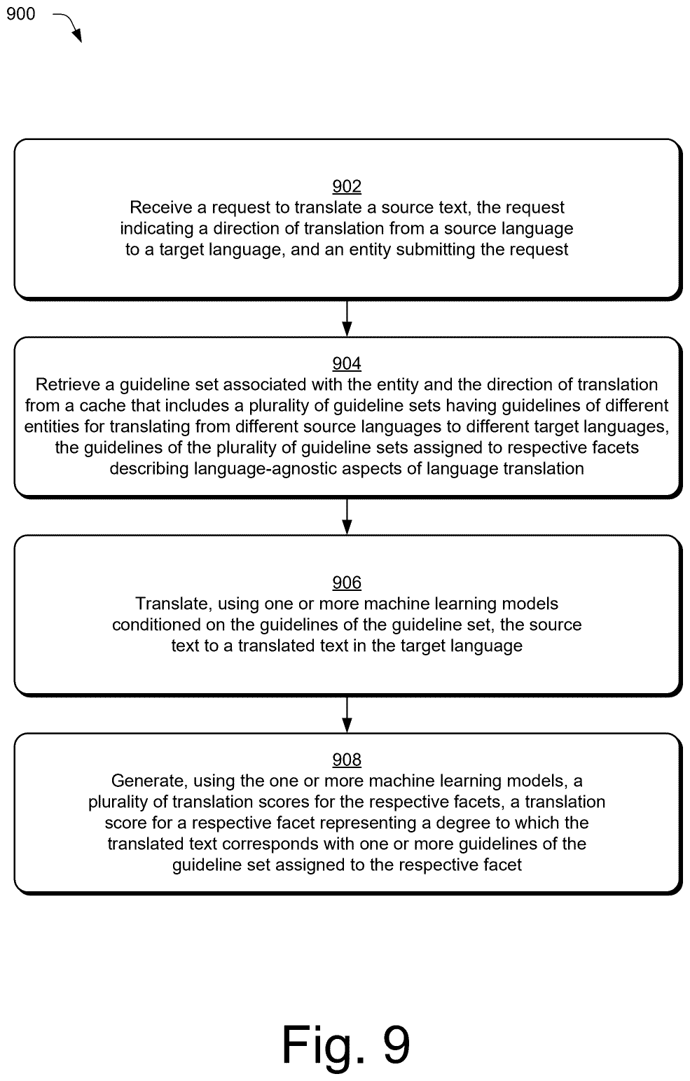

FIG. 9 is a flow diagram depicting a procedure 900 in an example implementation for guiding language translation with translation documents using machine learning. In the procedure 900, a request is received to translate a source text, and the request indicates a direction of translation from a source language to a target language and an entity submitting the request (block 902). By way of example, the translation system 112 receives a translation request 310 including source text 116 to be translated, an entity 302 submitting the translation request 310, and a translation direction 304 from a source language to a target language. In other words, the translation request 310 is a request submitted by an entity 302 to translate the source text 116 to the target language in accordance with the guidelines set forth in the translation document 118 associated with the entity 302 and the translation direction 304.

A guideline set associated with the entity and the direction of translation is retrieved from a cache that includes a plurality of guideline sets having guidelines of different entities for translating from different source languages to different target languages, and the guidelines of the plurality of guideline sets are assigned to respective facets describing language-agnostic aspects of language translation (block 904). For instance, the guideline extraction model 202 receives the translation facets 120 describing language-agnostic aspects of language translation that are consistently applicable across different translation directions 304. Moreover, the guideline extraction model 202 receives a plurality of translation documents 118 outlining entity-specific and language-specific guidelines of language translation for different entities 302 and different translation directions 304. For each translation document 118, the guideline extraction model 202 extracts guidelines 208 that are categorizable within the translation facets 120, and assigns the extracted guidelines 208 within respective translation facets 120.

Furthermore, the guideline extraction model 202 creates an entry 308 in the cache 306 for each set of guidelines 208 extracted from different translation documents 118. As a result, the cache 306 is pre-populated with a plurality of entries 308 each having different sets of guidelines 208 associated with different entities 302 and/or different translation directions 304. Thus, in response to receiving the translation request 310, the guideline retrieval module 312 retrieves the guidelines 208 from the cache 306 that are grouped with the particular entity 302 and the particular translation direction 304 indicated by the translation request 310.

The source text is translated to the translated text in the target language using one or more machine learning models conditioned on the guidelines in the guideline set (block 906). By way of example, the translation model 204 receives conditioning signals including the source text 116 and the guidelines 208 assigned to the respective translation facets 120, as retrieved from the cache 306. Based on the conditioning signals, the translation model 204 translates the source text 116 to the translated text 124 in the target language while adhering to the guidelines 208.

A plurality of translation scores are generated for the respective facets using the one or more machine learning models, and a translation score for a respective facet represents a degree to which the translated text corresponds with one or more guidelines of the guideline set assigned to the respective facet (block 908). For instance, the validation model 206 receives conditioning signals including the translated text 124 and the guidelines 208 assigned to the respective translation facets 120 as retrieved from the cache 306. Based on the conditioning signals, the validation model 206 generates a translation score 212 for each respective translation facet 120 capturing a degree to which the translated text 124 corresponds with the one or more guidelines 208 assigned to the respective translation facet 120. In one or more implementations, the translation system 112 controls output of the translated text 124 based on the translation scores 212, as further discussed above with reference to FIG. 4.

### Example System and Device

FIG. 10 illustrates an example system generally at 1000 that includes an example computing device 1002 that is representative of one or more computing systems and/or devices that implement the various techniques described herein. This is illustrated through inclusion of the translation system 112. The computing device 1002 is configurable, for example, as a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

What is claimed is:

1. A method implemented by a processing device, the method comprising:
receiving a plurality of facets describing language-agnostic aspects of language translation, a translation document describing language-specific rules for translating from a source language to a target language, and a source text in the source language;
extracting, using one or more machine learning models, a plurality of guidelines from the translation document, the plurality of guidelines assigned to respective facets of the plurality of facets; and
translating, using the one or more machine learning models conditioned on the plurality of guidelines assigned to the respective facets, the source text to a translated text in the target language.

2. The method of claim 1, further comprising generating, using the one or more machine learning models, a rationale for the translated text, the rationale including natural language text explaining how the translated text adheres to the plurality of guidelines.

3. The method of claim 1, further comprising grouping, in a cache, the plurality of guidelines assigned to the respective facets with an entity associated with the translation document and a direction of translation from the source language to the target language.

4. The method of claim 3, wherein the translating the source text includes:
receiving a translation request that specifies the direction of translation, and the entity submitting the translation request;
querying the cache with the direction of translation and the entity; and
retrieving, from the cache, the plurality of guidelines grouped with the entity and the direction of translation in the cache.

5. The method of claim 1, wherein the translating the source text is performed by a translation model of the one or more machine learning models, the translation model having been trained using supervised learning on a training dataset that includes a plurality of training samples, each training sample including a training source text in the source language and a ground truth translated text in the target language having been translated in accordance with the language-specific rules of the translation document.

6. The method of claim 1, further comprising generating, using the one or more machine learning models, a plurality of translation scores for the respective facets, a translation score for a respective facet representing a degree to which the translated text corresponds with one or more guidelines assigned to the respective facet.

7. The method of claim 6, further comprising generating, using the one or more machine learning models, a plurality of rationales for respective translation scores, a rationale for a respective translation score including natural language text explaining how the translated text adheres to the one or more guidelines assigned to a respective facet.

8. The method of claim 6, further comprising outputting, by the processing device, the translated text based on the plurality of translation scores meeting a translation quality threshold.

9. The method of claim 6, further comprising:
generating, by the processing device, a prompt based on one or more translation scores of one or more facets falling below a translation quality threshold, the prompt including instructions for correcting the translated text with respect to the one or more facets; and
translating, by the processing device and using the one or more machine learning models, the source text to an updated translated text in the target language, the one or more machine learning models conditioned on the prompt and the plurality of guidelines assigned to the respective facets.

10. The method of claim 6, wherein the generating the plurality of translation scores is performed by a validation model of the one or more machine learning models, the validation model having been trained using supervised learning on a training dataset that includes a plurality of training samples, each training sample including a text sample in the target language and a ground truth translation score for the text sample with respect to the one or more guidelines assigned to a respective facet.

11. A non-transitory computer-readable medium storing executable instructions, which when executed by a processing device, cause the processing device to perform operations comprising:
receiving a plurality of guidelines for translating from a source language to a target language, the plurality of guidelines assigned to respective facets of a plurality of facets representing language-agnostic aspects of language translation;
translating, using one or more machine learning models conditioned on the plurality of guidelines assigned to the respective facets, a source text in the source language to a translated text in the target language; and
generating, using the one or more machine learning models, a plurality of translation scores for the respective facets, a translation score for a respective facet representing a degree to which the translated text corresponds with one or more guidelines assigned to the respective facet.

12. The non-transitory computer-readable medium of claim 11, wherein the receiving the plurality of guidelines includes:
receiving the plurality of facets, and a translation document describing language-specific rules for translating from the source language to the target language;
extracting, using the one or more machine learning models, the plurality of guidelines from the translation document; and
assigning, using the one or more machine learning models, the plurality of guidelines to the respective facets.

13. The non-transitory computer-readable medium of claim 11, wherein the receiving the plurality of guidelines includes:
receiving a translation request that specifies a direction of translation from the source language to the target language, and an entity submitting the translation request; and
retrieving the plurality of guidelines from a cache that includes a plurality of guideline sets having guidelines of different entities for translating from different source languages to different target languages, the plurality of guidelines representing a guideline set grouped with the entity and the direction of translation in the cache.

14. The non-transitory computer-readable medium of claim 11, the operations further comprising generating, using the one or more machine learning models, a rationale for the translated text, the rationale including natural language text explaining how the translated text adheres to the plurality of guidelines.

15. The non-transitory computer-readable medium of claim 11, the operations further comprising generating, using the one or more machine learning models, a plurality of rationales for respective translation scores, a rationale for a respective translation score of including natural language text explaining how the translated text adheres to the one or more guidelines assigned to a respective facet.

16. The non-transitory computer-readable medium of claim 11, the operations further comprising outputting the translated text based on the plurality of translation scores meeting a translation quality threshold.

17. The non-transitory computer-readable medium of claim 11, the operations further comprising:
generating a prompt based on one or more translation scores of one or more facets falling below a translation quality threshold, the prompt including instructions for correcting the translated text with respect to the one or more facets; and
translating, using the one or more machine learning models, the source text to an updated translated text in the target language, the one or more machine learning models conditioned on the prompt and the plurality of guidelines assigned to the respective facets.

18. A system comprising:
a processing device;
a cache including a plurality of guideline sets having guidelines of different entities for translating from different source languages to different target languages, the guidelines of the plurality of guideline sets assigned to respective facets describing language-agnostic aspects of language translation; and
a memory storing instructions that, responsive to execution by the processing device, cause the processing device to perform operations including:
receiving a request to translate a source text, the request indicating a direction of translation from a source language to a target language, and an entity submitting the request;
retrieving, from the cache, a guideline set grouped with the entity and the direction of translation in the cache; and
translating, using one or more machine learning models conditioned on the guidelines of the guideline set, the source text to a translated text in the target language.

19. The system of claim 18, the operations further including:
receiving a plurality of facets describing the language-agnostic aspects of language translation, and a translation document describing language-specific rules for translating from the source language to the target language;
extracting, using the one or more machine learning models, the guidelines of the guideline set from the translation document, and assigning the guidelines to the respective facets; and
populating the cache with a cache entry that includes the entity, the direction of translation, and the guideline set.

20. The system of claim 18, the operations further including generating, using the one or more machine learning models, a plurality of translation scores for the respective facets, a translation score for a respective facet representing a degree to which the translated text adheres to the one or more guidelines assigned to the respective facet.
